(19) United States
(12) Patent Application Publication
(10) Pub. No.: US 2016/0012102 A1
(43) Pub. Date: Jan. 14, 2016

(54) SEARCHING WITH CONTEXTUALLY RELATED QUERIES

(71) Applicant: Microsoft Corporation, Redmond, WA (US)

(72) Inventors: Richard Wesley Holley, Redmond, WA (US); Christopher Heino, Seattle, WA (US); Ryan Wilhelm, Kirkland, WA (US)

(21) Appl. No.: 14/522,461

(22) Filed: Oct. 23, 2014

Related U.S. Application Data
(60) Provisional application No. 62/022,134, filed on Jul. 8, 2014.

(51) Int. Cl. G06F 17/30

(52) U.S. Cl. CPC G06F 17/30389

(57) ABSTRACT

In response to receiving a request for a query, one or more property values associated with the query may be defined in conjunction with the query to generate a contextually linked query. The contextually linked query may include a first property that provides a context for subsequent properties, where the subsequent properties may be concatenated to and provide a constraint on the first property. In some examples, the first property may be a sensitive data type property defining a type of sensitive data being queried, and the subsequent properties may be contextual properties, such as a sensitive match count or sensitive match confidence property. The contextually linked query may be submitted to a data store, and the query may be executed with the first property and/or the subsequent properties being applied to a same data set without a need for distinct columns for each property at the data store.

### CROSS-REFERENCE TO RELATED APPLICATIONS

This application claims priority to U.S. Provisional Application Ser. No. 62/022,134 filed on Jul. 8, 2014. The Provisional Application is herein incorporated by reference in its entirety.

### BACKGROUND

System data may be stored in a search index of a data store such that it may be queried by one or more users. Search queries may include one or more separate properties that are contextually related and which affect one another. For example, a query may execute a search for all emails from a specific person on a specific date. The person and date may be separate properties that are contextually related to the emails or within the emails, and which affect one another. In some approaches, a column may be created in the search index or database for each property of the query, but each additional column created may negatively impact a performance and capacity of the system.

Accordingly, current implementations to generate search queries could use improvements and/or alternative or additional solutions such that the one or more separate properties may be contextually linked within the search query, and thus prevent a need for distinct columns for each property at the data store.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to provision of contextually related queries. A request for a query and one or more property values associated within the requested query may be received, a contextually linked query may be generated by defining the one or more property values in conjunction with the query such that a first property provides a context for subsequent properties concatenated to the first property, and the contextually linked query may be submitted to a data store.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a conceptual diagram illustrating an example datacenter-based system where contextually related queries may be implemented;

FIG. 2 illustrates a conceptual system, where contextually related queries may be implemented, according to some embodiments;

FIG. 3 illustrates examples of one or more properties associated with a query that may be contextually linked;

FIG. 4 illustrates examples of one or more properties associated with a query that may be not be contextually linked;

FIG. 5 illustrates examples of contextually linked queries;

FIG. 6 illustrates an example process to generate a contextually linked query;

FIG. 7 is a block diagram of an example general purpose computing device, which may be used for generation of a contextually related query; and

FIG. 8 illustrates a logic flow diagram of a method for generation of a contextually related query, according to embodiments.

### DETAILED DESCRIPTION

As briefly described above, one or more contextually related properties may be associated with a query, each property including one or more property values. The property values may be defined in conjunction with the query to generate a query, where the properties are contextually linked. For example, the contextually linked query may include a first property that provides a context for subsequent properties, where the subsequent properties may be concatenated to and act as constraints on the first property. In some examples, users may be enabled to define a custom classification of the property values in order to adjust the query to fit their needs. The users may define a custom first property, and may include or omit one or more of the subsequent properties, for example. Once generated, the contextually linked query may be submitted to a data store such that the query may be executed with the first property and/or the subsequent properties being applied to a same data set without a need for distinct columns for each property at the data store.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for generation and implementation of contextually related queries. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

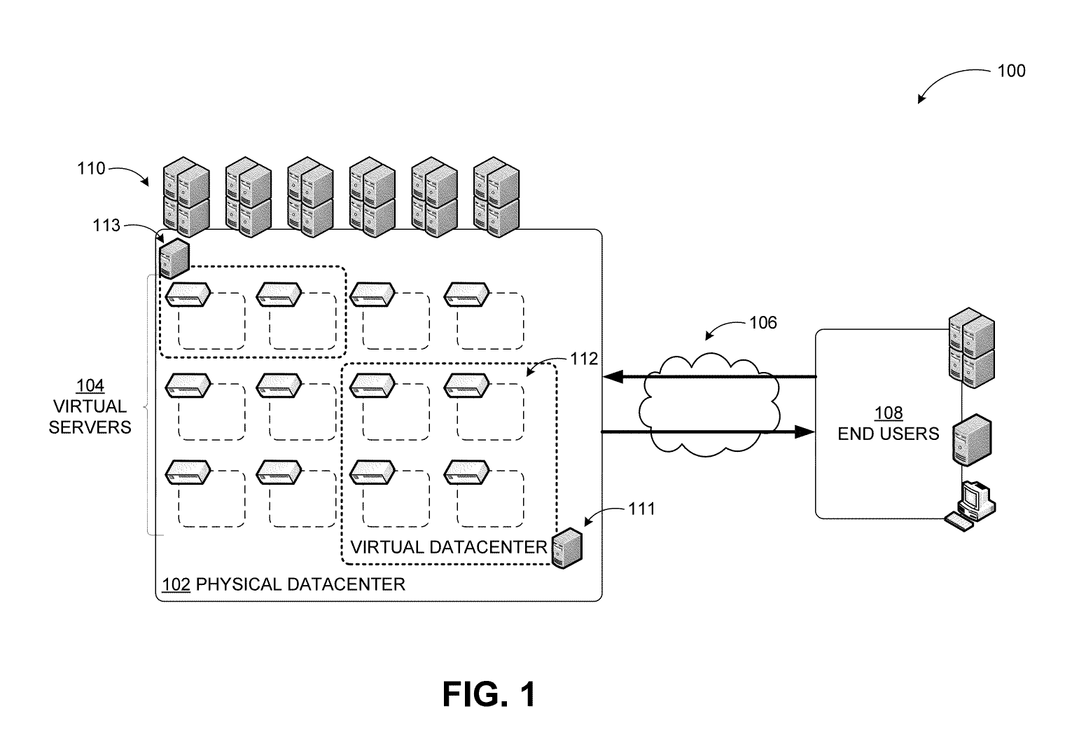

FIG. 1 includes a conceptual diagram illustrating an example datacenter-based system where contextually related queries may be implemented.

As shown in a diagram 100, a datacenter 102 may include one or more servers 110, 111, and 113 that are physical servers associated with software and underlying hardware of the datacenter 102. The one or more servers 110, 111, and 113 may be configured to execute one or more virtual servers 104. For example, the servers 111 and 113 may be configured to provide four virtual servers and two virtual servers, respectively. In some embodiments, one or more virtual servers may be combined into one or more virtual datacenters. For example, the four virtual servers provided by the servers 111 may be combined into a virtual datacenter 112. The virtual servers 104 and/or the virtual datacenter 112 may be configured to host a multitude of servers to provide cloud-related data/computing services such as various applications, data storage, data processing, or comparable ones to one or more end users 108, such as individual users or enterprise customers, via a cloud 106.

In some examples, a user may submit queries to various data stored at the datacenter 102. A query request from the user may include properties associated with the query, where one or more of the properties may be contextually related. Additionally, the query may include one or more non-contextual properties.

In one example, a user may request a query associated with a search on sensitive data within a data store managed by the datacenter 102. Example properties associated with the query may include a sensitive type property that provides context for one or more of a sensitive match count property and a sensitive match confidence property or associated count or confidence properties. In another example, the user may request a query associated with a search for content within the data store that contains a specific number of instances of an attribute, such as a word, a name, and/or a date. Example properties associated with the query may include an attribute type property that provides context for an attribute match count property.

Current approaches may include creating a separate column within a search index of the data store for each contextually related property. However, this may introduce a dependence on storage schema, where each additional column created may negatively impact a performance and capacity of datacenter storage. Furthermore, this approach may exclude support of user-defined custom properties, may not be scalable, and may not support localization of property names. Additionally, usability challenges may be presented to those writing queries who would have to remember large numbers of virtual property names.

Other current approaches may use Boolean operators, for example, “AND,” “NOT,” and “OR”, to contextually link properties. This approach may overload “AND” to associate properties, resulting in query trees that may be difficult to validate due to properties like associativity, commutativity, distributivity, DeMorgan's Law, and other similar examples. These properties may inadvertently introduce unexpected changes in logical interpretation of the query, and a match between the logical interpretation of the query and the user's intent may not be verifiable.

According to embodiments, use of contextually linked queries may simplify and increase efficiency of the queries submitted by the user. Some embodiments may involve concatenation of one or more subsequent properties to a first property, where the first property provides context for the subsequent properties, to generate a contextually linked query. The concatenated properties may be included to act as a constraint on the first property, or they may be omitted such that the first property has no constraints. The contextually linked query may be submitted to a data store and executed such that the first property and concatenated subsequent properties may be applied to a same data set without a need for distinct columns for each property at the data store.

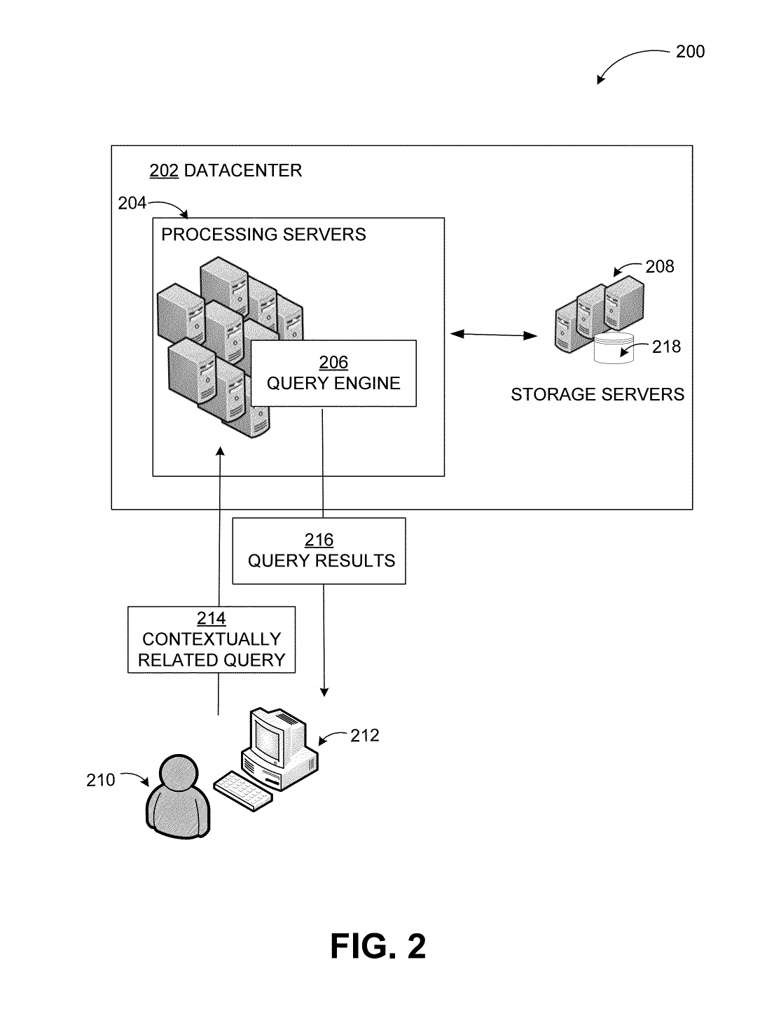

FIG. 2 illustrates a conceptual system, where contextually related queries may be implemented, according to some embodiments.

As illustrated in diagram 200, a datacenter 202 may include one or more processing servers 204 configured to, among other things, execute a query engine 206 for execution of contextually related queries on various data stored within one or more data stores of the datacenter 202. The stored data may be managed by the processing servers 204 or by dedicated data storage servers 208 (e.g., database servers), for example. The datacenter 202 may be associated with a user 210, and may receive the contextually related queries from a client device 212 associated with the user 210. The client device 212 may include an input device, a memory, and a processor, where the client device 212 may be a desktop computer, laptop, tablet, smart phone, and wearable, among other examples.

In an example embodiment, the user 210 may request a query through an input device of the client device 212. The input device may enable various input methods such as touch, gesture, eye tracking, voice recognition, pen, mouse, and keyboard input methods. The request for the query may be received at the processor of the client device 212 along with one or more property values associated with the requested query. The processor may define the property values in conjunction with the query such that a first property provides a context for subsequent properties concatenated to the first property in order to generate a contextually linked query 214.

In some examples, the subsequent properties may be optional. For example, subsequent properties may be included such that defined values of the subsequent properties constrain the first property or the subsequent properties may be omitted such that the first property may have no constraints. A wildcard value may be inserted for one or more of the omitted subsequent properties within the contextually linked query. Alternately, the value may be left empty for the omitted subsequent properties within the contextually linked query.

The processor may then submit the contextually linked query 214 to the datacenter 202, where the contextually linked query 214 may be received at the processing servers 204 of the datacenter 202. The processing servers 204 may execute the query engine 206 to execute the contextually linked query 214 within a data store 218 managed by the data storage servers 208. The contextually linked query 214 may be executed with the first property and/or the subsequent properties being applied to the same data set without a need for distinct columns for each property at the data store 218. Following execution of the contextually linked query 214, the query engine 206 may process query results 216 for transmission to the user 210 through the client device 212.

In some embodiments, custom classification and localization of at least the first property by the user 210 may be enabled through a user interface provided by a display of the client device 212. For example, the user 210 may custom-define the first property, and the user 210 may include or omit one or more of the subsequent properties to adjust the query to fit their search needs. Furthermore, the user 210 may be enabled to define a localization for the first property. For example, if the first property is a name, the user may be able to search content for the name property in a language spoken by the user issuing the query.

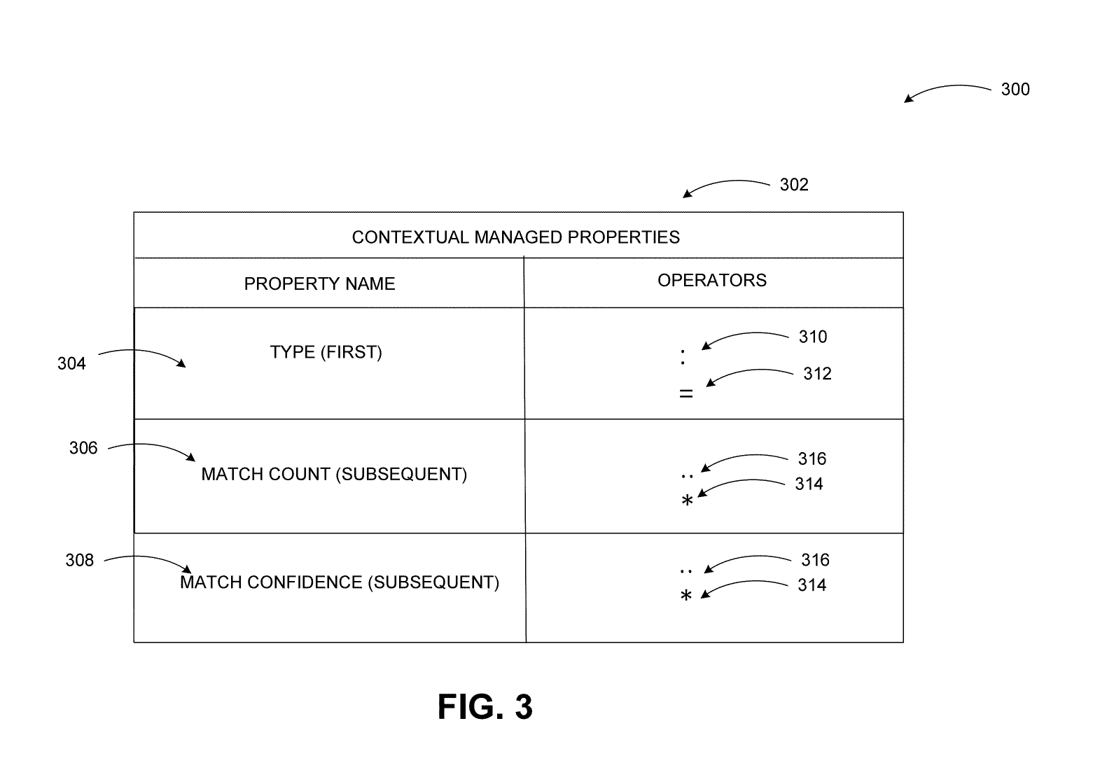

FIG. 3 illustrates examples of one or more properties associated with a query that may be contextually linked.

As previously discussed, in conjunction with FIG. 2, in response to receiving a request for a query, a processor may define one or more property values associated with the query in conjunction with the query to generate a contextually linked query. A first property may provide a context for subsequent properties, which may be concatenated to the first properties within the contextually linked query, but are not required.

In diagram 300, an example table 302 displays one or more properties associated with a requested query that may be contextually linked. A first property may be a type property 304, where a value of the type property 304 may be defined as a type of data that is being queried. In some examples, the requested query may be associated with a search on sensitive data. In such examples, the first property may be a sensitive data type property, where a value of the sensitive data type property may be defined as a type of sensitive data that is being queried. The value of the sensitive data type property may include a credit card number, a social security number, an identification number (e.g., a passport number, a license number, etc.) a medical record number, and a banking account number, among other examples. In other examples, the type property 304 may include an attribute, such as a name, a date, and/or a word, where a value of the type property 304 may be defined as a type of attribute that is being queried.

The subsequent properties may include one or more contextual properties related to the type property 304. The contextual properties may include a match count property 306 and a match confidence property 308, for example. The type property 304 may provide context for subsequent properties, and thus subsequent property values may not be defined in the query without the value of the type property 304 (e.g., the data type) first being defined. A value of the match count property 306 may be defined as a number of instances the defined data type is found in content, such as data, documents, files, and the like, within the data store. A value of the match confidence property 308 may be defined as a percentage of confidence that each instance of the defined data type is not a false positive.

In some embodiments, the match count property 306 and the match confidence property 308 may be optional. For example, values of the match count property 306 and the match confidence property 308 may be included and defined in the query to provide one or more constraints on the type property 304. Alternately, one or both of the match count property 306 and the match confidence property 308 may be omitted from the query such that the type property 304 has less or no constraints.

The example table 302 may also display operators associated with each property that may be used within the query. The type property 304 may be associated with a semi-colon 310 or an equal sign 312, to define the type of data being queried. For example, SensitiveType=“Credit Card Number” or SensitiveType:“Credit Card Number”, which may substantially have a same meaning within the query (i.e., the sensitive data being queried is a credit card number). In some examples, the type property 304 may support custom types and/or sensitive types that the user may define. The custom types may be supported without having to change storage schema within the data store by adding new columns for each custom type's associated match count and match confidence property as performed in current implementations. Instead, according to embodiments, a new value may be added to an existing type property column within the data store.

The match count property 306 and the match confidence property 308 may be associated with integer operators 316. Specifically, the match count property 306 may be associated with any positive integers equal to or greater than 1, and the match confidence property 308 may be associated with positive integers between 1 and 100. In some examples, the integer operators 316 may indicate ranges. Additionally, the match count property 306 and the match confidence property 308 may be associated with an asterisk operator 314 when one or both values of the match count property 306 and the match confidence property 308 are inserted with a wildcard value. The asterisk operator 314 may indicate that no constraints of count and/or confidence may be placed on the type property 304 when the query is executed. Therefore, the query may search for all content containing the type of data defined regardless of a count or a confidence. In other examples, one or both values of the match count property 306 and the match confidence property 308 may be left empty within the contextually linked query to indicate that no constraints of count and/or confidence may be placed on the type property 304 when the query is executed.

Table 1A and 1B below may provide example integer operators 316 and asterisk operators 314 for the match count property 306 and the match confidence property 308, respectively, and their meaning within the query. These are illustrative examples only, and are not intended to limit the embodiments in any way.

TABLE 1A
Example Operators for the Match Count Property

| Match Count | |
|---|---|
| Property Value | Meaning |
| 5 | Content includes 5 instances of data type |
| 5 . . . | Content includes 5 or more instances of data type |
| . . . 5 | Content includes 5 or less instances of data type |
| 5 . . . 10 | Content includes between 5 and 10 instances of data type |
| * | Content includes any number of instances of data type |

TABLE 1B
Example Operators for the Match Confidence Property

| Match | |
|---|---|
| Confidence | |
| Property | |
| Value | Meaning |
| 85 | 85% confidence that the instance is the data type |
| 85 . . . | 85% or higher confidence that the instance is the data type |
| . . . 85 | 85% or lower confidence that the instance is the data type |
| 85 . . . 100 | Between 85% and 100% confidence that the instance is |
| | the data type |
| * | Any % of confidence that the instance is the data type |

In some embodiments, Boolean operators may be used in the contextually linked query to connect one or more of the contextual properties and predicates. For example, a contextually linked query employing Boolean operators may look like the following:

SensitiveType=“Credit Card Number” WITH Count=50 AND Confidence=85

where count and confidence may be correctly associated with the sensitive type such that the query may be verified and executed.

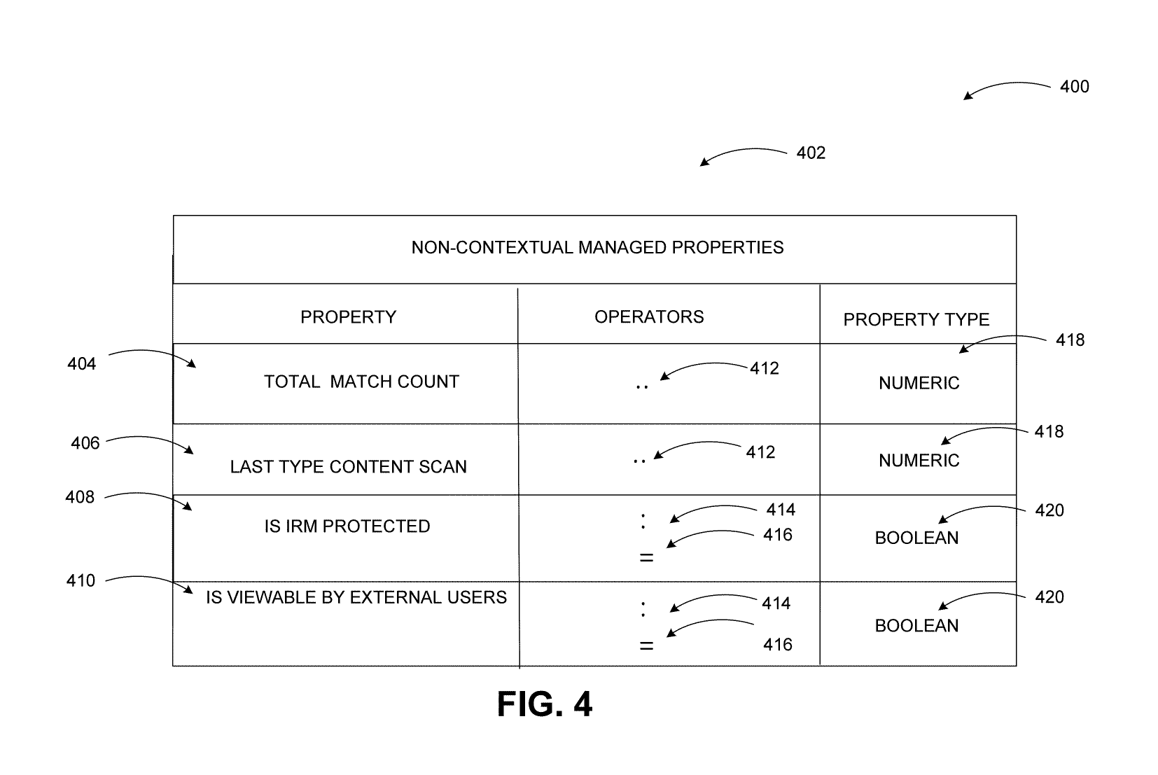

FIG. 4 illustrates examples of one or more properties associated with a query that may not be contextually linked, according to embodiments.

A requested query may include one or more property values associated with the query. The property values may be defined in conjunction with the query such that a first property provides a context for subsequent properties concatenated to the first property in order to generate a contextually linked query. The first property may be a type property that defines a type of data that is being queried, where the data type may include sensitive data or a data attribute, such as a name, a date, and/or a word, for example. Subsequent properties may include one or more contextual properties related to the type property, such as a match count property and a match confidence property. Additionally, there may be one or more other properties associated with the query that are not contextually linked.

In diagram 400, an example table 402 displays the properties associated with a requested query that may not be contextually linked. The non-contextual properties may be numeric property types 418 or Boolean property types 420 that include a total match count property 404, a last type content scan property 406, an “is IRM protected” property 408, an “is viewable by external users” property 410, for example. The example table 402 may also display operators associated with each of the non-contextual properties that may be used within the query.

The total match count property 404 may be a numeric property type 418, where a value of the total match count property 404 may be defined as a total number of instances a data type is found within content of the data store. For example, the value of the total match count property 404 may indicate a total number of instances of any type of sensitive data, such as a total count of instances of credit card numbers, social security numbers, and bank account numbers, among other examples. An integer operator 412 may be associated with the total match count property 404, where values of the total match count property 404 may include any positive integers equal to or greater than 1. In some examples, the integer operator 412 may indicate ranges.

The last type content scan property 406 may be a numeric property type 418, where a value of the last type content scan property 406 may be defined as a date when a scan was last performed on content for a data type within the data store. For example, the value of the last type content scan property 406 may be a last date the content was scanned for sensitive data. The last type content scan property 406 may also be associated with the integer operator 412, where values of the last type content scan property 406 may include integers in a form of a date.

The “is IRM protected” property 408 may be a Boolean property type 420, where a value of the “is IRM protected” property 408 may define whether content within the data store is protected by information rights management (IRM) technologies. The “is IRM protected” property 408 may be associated with a semi-colon 414 or an equal sign 416, where the value of the “is IRM protected” property 408 may include TRUE or FALSE. The semi-colon 414 and the equal sign 416 operators may substantially have a same meaning within the query. For example, isIRMProtected=FALSE and isIRMProtected:FALSE may both indicate that the query may execute a search within the data store for content that is not IRM protected.

The “is viewable by external users” property 410 may be a Boolean property type 420, where a value of the “is viewable by external users” property 410 may define whether content within the data store has been shared with one or more external users. The “is viewable by external users” property 410 may be also associated with a semi-colon 414 or an equal sign 416, where the value of the “is viewable by external users” property 410 may include TRUE or FALSE. As previously discussed in conjunction with the “is IRM protected” property 408, the semi-colon 414 and the equal sign 416 may substantially have the same meaning within the query.

In some embodiments, Boolean operators, such as “AND,” “OR,” and “NOT” may be used to connect one or more of the properties and predicates. The properties may include both contextual properties, such as count and confidence properties as discussed in conjunction with FIG. 3, and the non-contextual properties, such as those displayed in table 402. For example, a query employing Boolean operators to connect contextual and non-contextual properties to predicates may look like the following:

SensitiveType=“Credit Card Number|5 . . . ” AND

isIRMProtected=FALSE

where the query may execute a search for content within the data store that includes 5 or more credit card numbers (with any confidence) and that is not IRM protected.

According to an example scenario, a corporation may be associated with a collaboration service that has accrued thousands of corporation documents over numerous site collections. The corporation's administration, having recently read about a national store chain which accidentally leaked thousands of credit cards and social security numbers, may be concerned about sensitive information within content accrued by the collaboration service, particularly credit cards and social security numbers. The administration may request a query for all content, such as data, documents, and files, with credit cards and social security numbers. The results back may be extensive, as it is not uncommon for content to have these sensitive types, especially from the sales and human resource departments, of the corporation. The administration may narrow down the results by requesting a query for content that includes 5 or more credit card numbers, and specifically content that is not IRM Protected and which has been shared with users external to the organization. Thus, the following query may be generated connecting contextual properties and non-contextual properties with predicates:

SensitiveType=“Credit Card Number|5 . . . ” AND

isIRMProtected=FALSE AND isViewableByExternalUsers=TRUE.

The results of the query may provide the administration the content that includes 5 or more credit card numbers, that is not IRM Protected, and that has been shared with users external to the organization. For example, the content may have been stored in cloud storage folders that were long-ago shared with a partner company and have been repurposed for this storage. The administration may export the results and contact the owners of the content to have it moved to a safe location.

Furthermore, Boolean operators may connect contextual and non-contextual properties to complex predicates:

(SensitiveType=“Credit Card Number|5 . . . |85 . . . ”

AND isIRMProtected=FALSE AND isViewableByExternalUsers=TRUE) OR

(SensitiveType=“Social Security Number|5 . . . 100”

AND NOT isViewableByExternalUsers=FALSE)

where the query may execute a search within the data store for content that includes 5 or more credit card numbers with an 85% or higher confidence, that is not IRM protected, and that has been viewed by one or more external users; or content that includes between 5 and 10 social security numbers (with any confidence), that is not IRM protected, and that has been viewed by one or more external users.

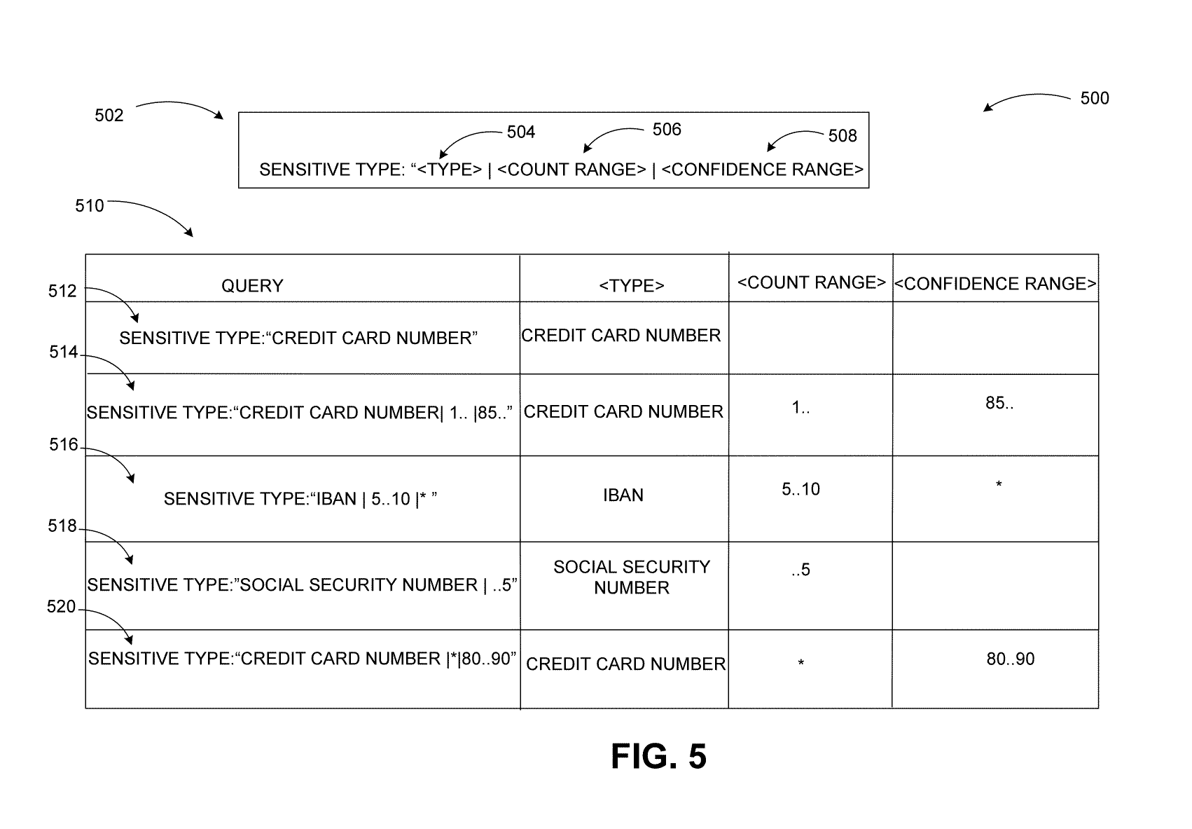

FIG. 5 illustrates examples of contextually linked queries, according to embodiments. A contextually linked query may include one or more contextually linked properties associated with the query, where each property may include a single value or multiple values, such as a range of values. Example embodiments are described herein for a contextually linked query associated with a search on sensitive data, where the properties associated with the query include sensitive type, count, and confidence properties.

As illustrated in diagram 500, an example format of a contextually linked query 502 may include a sensitive type property associated with a type value 504, a sensitive match count property associated with a count value 506, and a sensitive match confidence property associated with a confidence value 508. The sensitive match count property and sensitive match confidence property may be concatenated to the sensitive type property, and in some examples may be optional. For example, one or both of the sensitive match count property and sensitive match confidence property may be included to act as a constraint on the sensitive type property, or they may be omitted such that the sensitive type property has no constraints. If the one or both of the sensitive match count property and sensitive match confidence property are omitted, values of the properties may be replaced with a wildcard value or the values of the properties may be left empty.

The type value 504 of the sensitive type property may be defined in the left-most position of the query 502 as a type of the sensitive data that is being queried in a data store. For example, the type value 504 may include a credit card number, a social security number, an identification number (e.g., a passport number, a license number, etc.) a medical record number, and a banking account number, among other examples. The count value 506 of the sensitive match count property and the confidence value 508 of the sensitive match confidence property may be defined in positions to the right of the sensitive type property in the query 502. The count value 506 of the sensitive match count property may be defined as a number of instances the sensitive data type is found in content within the data store, where the count value 506 may be a single value or a range of values. The confidence value 508 of the sensitive match confidence property may be defined as a percentage confidence that each instance is not a false positive, where the confidence value 508 may be a single value or a range of values.

As further illustrated in the diagram 500, a table 510 displays specific examples of contextually linked queries submitted to a data store. These are illustrative examples only, and are not intended to limit the embodiments in any way.

Query 512 may be defined as SensitiveType: “Credit Card Number”. The type value 504 of the sensitive type property may indicate the sensitive data being queried is a credit card number. The lack of count value 506 and confidence value 508 for the sensitive match count property and sensitive match confidence property may indicate that the count and confidence constraints have been omitted from the query 512, which may be interpreted as any values being acceptable. Accordingly, the query 512 may execute a search within the data store for content containing credit card numbers, where the content may include any number of credit card numbers at any confidence.

Query 514 may be defined as SensitiveType: “Credit Card Number|1 . . . |85 . . . ”. The type value 504 of the sensitive type property may indicate the sensitive data being queried is a credit card number. The count value 506 of the sensitive match count property 506, 1 . . . , may indicate one or more instances of credit card numbers. The confidence value 508 of the sensitive match confidence property 508, 85 . . . , may indicate an 85% or higher confidence that the one or more instances are actually credit card numbers and not false positives. Accordingly, the query 514 may execute a search within the data store for content containing one or more credit card numbers, and where a confidence that the content includes the one or more credit card number is 85% or higher.

Query 516 may be defined as SensitiveType: “IBAN|5 . . . 10|*”. The type value 504 of the sensitive type property may indicate the sensitive data being queried is an international banking account number (IBAN). The count value 506 of the sensitive match count property 506, 5 . . . 10, may indicate 5 to 10 instances of IBANs. The confidence value 508 of the sensitive match confidence property 508, *, may indicate a wildcard value has been inserted as the confidence constraint and therefore, indicates any confidence that the 5 to 10 instances were actually IBANs and will be accepted. Accordingly, the query 516 may execute a search within the data store for content containing between 5 and 10 IBANs, and any confidence that the content includes the 5 to 10 IBANs.

Query 518 may be defined as SensitiveType: “Social Security Number| . . . 5|”. The type value 504 of the sensitive type property may indicate the sensitive data being queried is a social security number. The count value 506 of the sensitive match count property 506, . . . 5, may indicate five or fewer instances of social security numbers. A lack of confidence value 508 for the sensitive match confidence property may indicate that the confidence constraint has been omitted from the query 518 and therefore, indicate any confidence that the 5 or fewer instances are actually social security numbers and not false positives. Accordingly, the query 518 may execute a search within the data store for content containing 5 or less instances of social security numbers, and any confidence that the content includes the 5 or fewer instances of the social security numbers.

Query 520 may be defined as SensitiveType: “Credit Card Number|*|80 . . . 90|”. The type value 504 of the sensitive type property may indicate the sensitive data being queried is a credit card number. The count value 506 of the sensitive match count property, *, may indicate a wildcard value has been inserted as the count constraint and therefore, indicates any number of instances of credit card numbers. The confidence value 508 of the sensitive match confidence property 508, 85 . . . 90, may indicate an 80% to 90% confidence range that the any number of instances were actually credit card numbers and not a false positive. Accordingly, the query 520 may execute a search within the data store for content containing any number of credit card numbers, where a confidence that the content includes the credit card numbers is from 80% to 90%.

In the example queries 512-520 provided above, an equal sign may replace the colon as an operator, and have a substantially same meaning. Furthermore, any tabs, new lines, and/or other forms of whitespace at a front end or a back end position of the sensitive type property may be ignored. For example, the following two queries may have the same meaning:

SensitiveType: “Credit Card Number |6 . . . ”

SensitiveType: “Credit Card Number|6 . . . ”

where the meaning may be to execute a search within the data store for content containing 6 or more credit card numbers, and any confidence that the content includes the 6 or more credit card numbers.

In some embodiments, Boolean operators may be used in a contextually linked query to connect one or more of the properties and predicates. For example, a contextually linked query employing Boolean operators may look like the following:

SensitiveType=“Credit Card Number” WITH Count=50 AND Confidence=85

where count and confidence may be correctly associated with the sensitive type such that the query may be verified and executed. Actual language (including both spoken and programming languages) used to generate the query may change, but the functionality may remain the same, providing context to properties with a simple operator. In other examples, the Boolean operators may further enable connection of contextual and non-contextual properties and predicates. Table 2 below provides examples of Boolean operators connecting properties, contextual and non-contextual, and predicates to generate a query. These are illustrative examples only, and are not intended to limit the embodiments in any way.

TABLE 2
Example Queries Connecting Contextual and Non-Contextual Properties and
Predicates Using Boolean Operators

| Query | Meaning |
|---|---|
| SensitiveType:“Credit Card Number \|5.. \|80..” | Execute a search within the data store for |
| AND isIRMProtected=TRUE | content including 5 or more credit card numbers |
| | and a confidence of at least 80% and which are |
| | IRM Protected |
| SensitiveType:”Credit Card Number \|5..” | Execute a search within the data store for |
| AND isViewableByExternalUsers | content including 5 or more credit card numbers |
| | and that has been shared with users external to |
| | the organization |
| TotalSensitiveMatchCount>5 | Execute a search within the data store for |
| | content that includes more than 5 Sensitive |
| | Types of any type |
| TotalSensitiveMatchCount>0 AND | Execute a search within the data store for |
| isIRMProtected=TRUE | content with any Sensitive Types, of any count |
| | or confidence, that have been IRM Protected |
| TotalSensitiveMatchCount>0 AND | Execute a search within the data store for |
| isViewableByExternalUsers=TRUE | content with any Sensitive Types, of any count |
| | or confidence, that have been shared with users |
| | external to the organization |

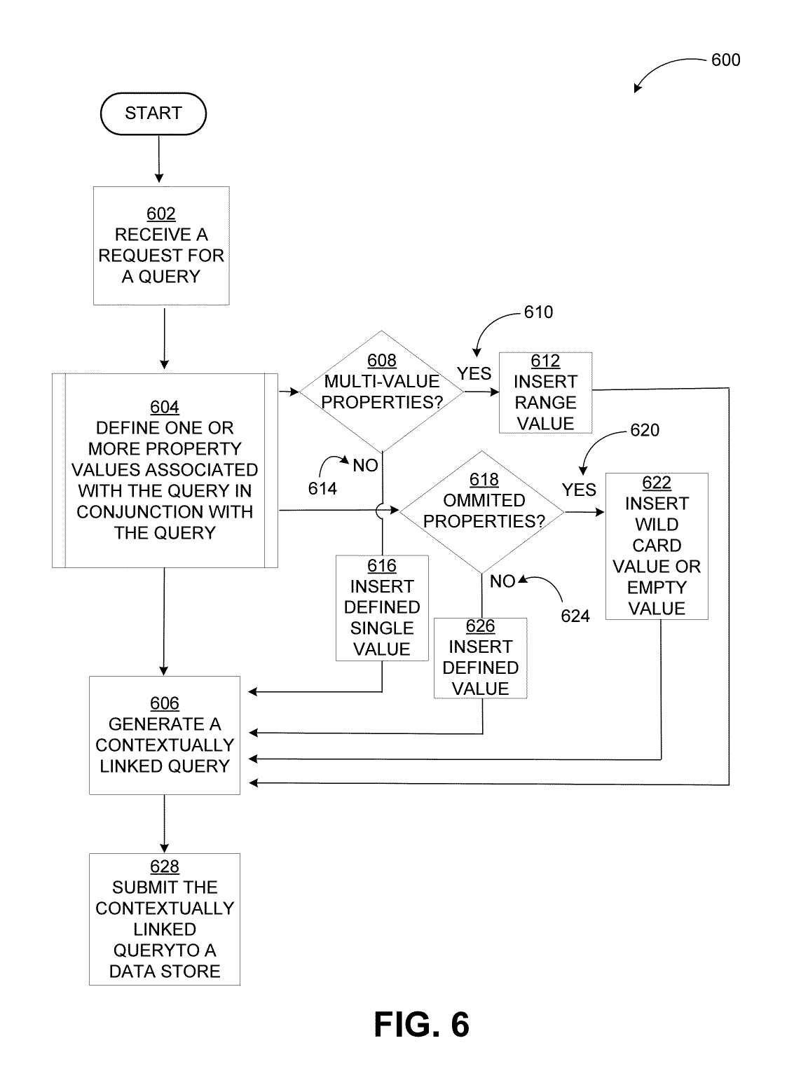

FIG. 6 illustrates an example process to generate a contextually linked query. The example process to generate the contextually linked query may be performed by a computing device, for example. The computing device may include an input device, a memory, and a processor, among other components.

As illustrated in diagram 600, the processor of the computing device may receive a request for a query 602 from a user, along with one or more property values associated with the requested query. The processor may define the property values in conjunction with the query at sub-process 604. The property values may be defined such that a first property may provide context for subsequent properties concatenated to the first property in order to generate a contextually linked query 606.

The processor may determine if one or more of the property values include multiple values at decision 608. If the property values include multiple values 610, a range value may be inserted 612 for the property value within the contextually linked query. If the property values do not include multiple values 614, the defined single property value may be inserted 616 within the contextually linked query.

The processor may determine if one or more of the subsequent property values have been omitted by the user at decision 618. If one or more of the subsequent property values are omitted 620, a wildcard value or an empty value may be inserted 622 for the subsequent property values within the contextually linked query. If one or more of the subsequent property values have not been not omitted 624, the defined subsequent property values may be inserted 626 within the contextually linked query.

The processor may submit the contextually linked query to a data store 628. The contextually linked query may be submitted such that the query may be executed with the first property and/or the subsequent properties being applied to a same data set without a need for distinct columns for each property at the data store.

The examples in FIG. 1 through 6 have been described with specific platforms including datacenters, systems, computing devices, processes, and interactions. Embodiments are not limited to systems according to these example configurations. Contextually related queries may be generated and implemented in configurations using other types of platforms including datacenters, systems, computing devices, processes, and interactions in a similar manner using the principles described herein.

Use of contextually linked queries may simplify and increase efficiency of queries submitted by the user. For example, the contextually linked query may be executed on data stored within the data store such that the properties are applied to a same data set without a need for distinct columns for each property at the data store. Thus, contextually linked queries may advantageously require less storage space within the data store, and therefore reduce hardware requirements. Furthermore, contextually linked queries may advantageously improve usability. For example, the user may be enabled to custom define the first property (that provides context to subsequent properties), as well as include or omit constraining subsequent properties to adjust the query to fit their search needs. Additionally, the user may be enabled to define a localization for the first property through the user interface such that the user may be able to search content in a language defined by the user.

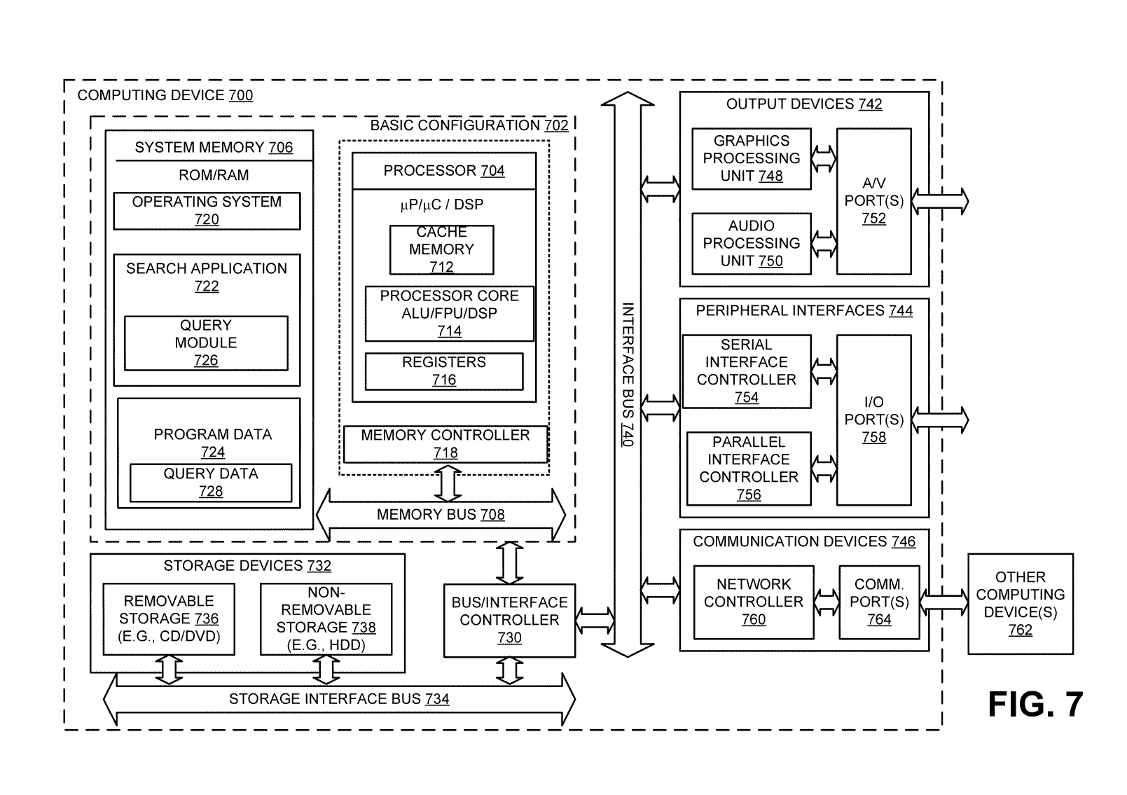

FIG. 7 and the associated discussion are intended to provide a brief, general description of a general purpose computing device, which may be used for generation of a contextually related query, arranged in accordance with at least some embodiments described herein.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a search application 722, a query module 726, and program data 724. The search application 722 may receive a request for a query along with one or more property values associated with the query from a user, and execute the query module 726, where the query module 726 may be configured to generate a contextually linked query by defining the property values such that a first property provides one or more subsequent properties with context. The query module 726 may then be configured to submit the contextually linked query to a data store such that the query may be executed with the first property and/or the subsequent properties being applied to a same data set without a need for distinct columns for each property at the data store. Program data 724 may include, among other things, query data 728 related to the defined property values associated with the query, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 746 includes a network controller 760, which may be arranged to facilitate communications with one or more other computing devices 762 over a network communication link via one or more communication ports 764. The one or more other computing devices 762 may include servers, client devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to provide contextually related queries. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

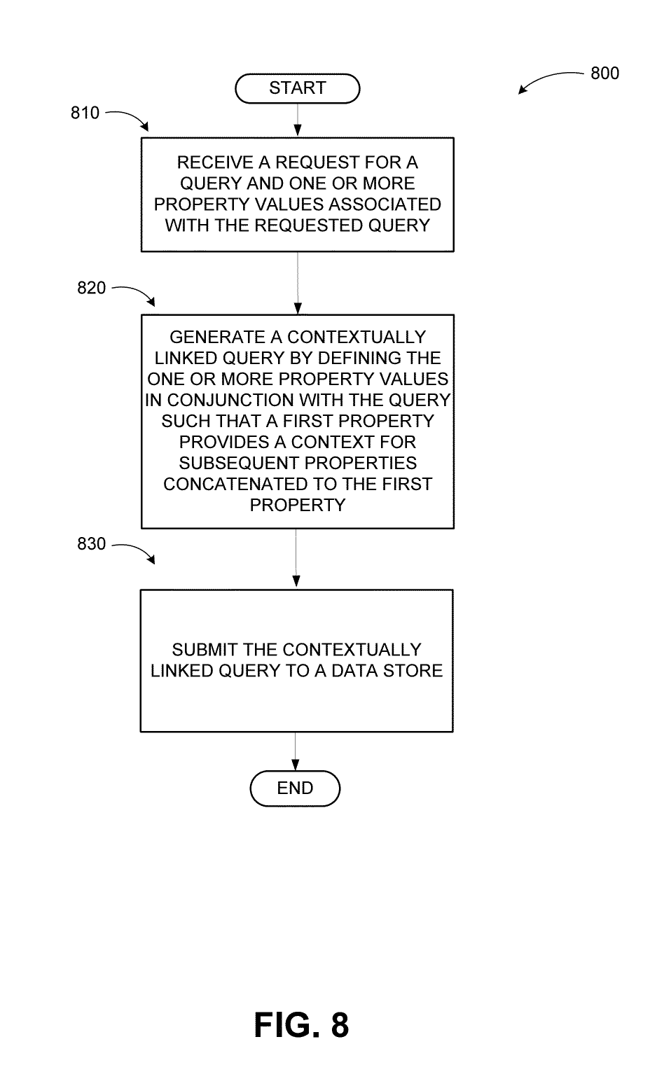

FIG. 8 illustrates a logic flow diagram for process 800 of a method for generation of a contextually linked query, according to embodiments. Process 800 may be implemented on a server, computing device, or other system.

Process 800 begins with operation 810, where a request for a query may be received from a user. The request may include one or more property values associated with the requested query.

At operation 820, the property values may be defined in conjunction with the query to generate a contextually linked query. The property values may be defined such that a first property provides a context for one or more subsequent properties concatenated to the first property. The subsequent properties may be optional. For example, the subsequent properties may be included to act as one or more constraints on the first property, or the subsequent properties may be omitted such that the first property has no constraints. In some examples, one or more of the properties within the contextually linked query may have multiple values that are defined as a range of values. In other examples, a wildcard value may be inserted for values of one or more properties within the contextually linked query in response to determination that the properties are omitted. Alternately, values may be left empty for one or more properties within the contextually linked query in response to determination that the properties are omitted.

At operation 830, the contextually linked query may be submitted to a data store. The contextually linked query may be submitted such that the query may be executed with the first property and/or the subsequent properties being applied to a same data set without a need for distinct columns for each property at the data store.

The operations included in process 800 are for illustration purposes. Generation and implementation of contextually related queries may be implemented by similar processes with fewer or additional steps, as well as in different order of operations using the principles described herein.

According to some embodiments, a method to provide contextually linked queries may be provided. An example method may include a means for receiving a request for a query and one or more property values associated with the requested query, a means for generating a contextually linked query by defining the property values in conjunction with the query such that a first property provides a context for subsequent properties concatenated to the first property, and a means for submitting the contextually linked query to a data store.

According to some examples, methods to provide contextually linked queries may be provided. An example method may include receiving a request for a query and one or more property values associated with the requested query, generating a contextually linked query by defining the property values in conjunction with the query such that a first property provides a context for subsequent properties concatenated to the first property, and submitting the contextually linked query to a data store.

In other examples, generation of the contextually linked query may include defining the property values in conjunction with the query such that the subsequent properties provide constraints to the first property. The subsequent properties may be optional. The query may be executed with the first property and the subsequent properties being applied to a same data set without a need for distinct columns for each property at the data store. Insertion of a wildcard value for one or more properties within the contextually linked query may be enabled.

In further examples, at least one of the properties within the contextually linked query may have multiple values. The multiple values of the at least one of the properties within the contextually linked query may be defined as a range of values. Localization of at least the first property may be enabled. Custom classification of at least the first property may be enabled. A user may be enabled to define the custom classification of the first property. Use of Boolean operators may be enabled to connect one or more properties and predicates. Connection of contextual and non-contextual properties and predicates may also be enabled.

According to some embodiments, systems to provide contextually linked queries may be described. An example system may include a computing device comprising an input device, a memory, and a processor. The processor, in conjunction with instructions stored in the memory, may be configured to receive a request for a query and one or more property values associated with the requested query through the input device, generate a contextually linked query by defining the property values in conjunction with the query such that a first property provides a context for subsequent properties concatenated to the first property and the subsequent properties provide constraints to the first property, and submit the contextually linked query for execution. The example system may also include a data store communicatively linked to the computing device, where the contextually linked query may be executed on data stored at the data store.

In other embodiments, insertion of a wildcard value, multiple values, and/or a range of values for one or more properties within the contextually linked query may be enabled. A display device may be communicatively coupled to the processor, where a user interface may be provided through the display device to enable a user to define a custom classification for the first property. The user may be enabled through user interface to define a localization for the first property.

According to some examples, methods to provide contextually linked queries for sensitive data may be provided. An example method may include receiving a request for a query associated with a search on sensitive data, determining one or more contextual properties associated with the requested query, where a first property is a sensitive data type property defining a type of the sensitive data that is being queried, and enabling a user to define the contextual properties that are configured to provide one or more constraints on the sensitive data type property. The example method may also include generating a contextually linked query by concatenating the defined contextual properties on the sensitive data type property, and submitting the contextually linked query to a data store.

In other examples, values for the contextual properties may include a single value, multiple values, a value range, a wildcard value, or an empty value. The contextual properties may include a sensitive match count and a sensitive match confidence. Lack of a contextual property may be interpreted as any values for the lacking contextual property being acceptable.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide contextually linked queries, the method comprising:
receiving a request for a query and one or more property values associated with the requested query;
generating a contextually linked query by defining the one or more property values in conjunction with the query such that a first property provides a context for subsequent properties concatenated to the first property; and
submitting the contextually linked query to a data store.

2. The method of claim 1, wherein generating the contextually linked query comprises:
defining the one or more property values in conjunction with the query such that the subsequent properties provide constraints to the first property.

3. The method of claim 2, wherein the subsequent properties are optional.

4. The method of claim 1, further comprising:
executing the query with the first property and the subsequent properties being applied to a same data set without a need for distinct columns for each property at the data store.

5. The method of claim 1, further comprising:
enabling insertion of a wildcard value for one or more properties within the contextually linked query.

6. The method of claim 1, wherein at least one of the properties within the contextually linked query has multiple values.

7. The method of claim 6, wherein the multiple values of the at least one of the properties within the contextually linked query are defined as a range of values.

8. The method of claim 1, further comprising:
enabling localization of at least the first property.

9. The method of claim 1, further comprising:
enabling custom classification of at least the first property.

10. The method of claim 9, further comprising:
enabling a user to define the custom classification of the first property.

11. The method of claim 1, further comprising:
enabling use of Boolean operators to connect one or more properties and predicates.

12. The method of claim 11, further comprising:
enabling connection of contextual and non-contextual properties and predicates.

13. A system to provide contextually linked queries, the system comprising:
a computing device comprising an input device, a memory, and a processor, wherein the processor, in conjunction with instructions stored in the memory, is configured to:
receive a request for a query and one or more property values associated with the requested query through the input device;
generate a contextually linked query by defining the one or more property values in conjunction with the query such that a first property provides a context for subsequent properties concatenated to the first property and the subsequent properties provide constraints to the first property; and
submit the contextually linked query for execution; and
a data store communicatively linked to the computing device, wherein the contextually linked query is executed on data stored at the data store.

14. The system of claim 13, wherein the processor is further configured to:
enable insertion of one or more of a wildcard value, multiple values, and a range of values for one or more properties within the contextually linked query.

15. The system of claim 13, further comprising:
a display device communicatively coupled to the processor, wherein the processor is further configured to:
provide a user interface through the display device to enable a user to define a custom classification for the first property.

16. The system of claim 15, wherein the processor is further configured to:
enable the user through user interface to define a localization for the first property.

17. A method to provide contextually linked queries for sensitive data, the method comprising:
receiving a request for a query associated with a search on sensitive data;
determining one or more contextual properties associated with the requested query, wherein a first property is a sensitive data type property defining a type of the sensitive data that is being queried;
enabling a user to define the one or more contextual properties that are configured to provide one or more constraints on the sensitive data type property;
generating a contextually linked query by concatenating the defined one or more contextual properties on the sensitive data type property; and
submitting the contextually linked query to a data store.

18. The method of claim 17, wherein values for the one or more contextual properties include a single value, multiple values, a value range, a wildcard value, or an empty value.

19. The method of claim 17, wherein the one or more contextual properties include a sensitive match count and a sensitive match confidence.

20. The method of claim 17, wherein lack of a contextual property is interpreted as any values for the lacking contextual property being acceptable.
